(19) United States
(12) Patent Application Publication
(10) Pub. No.: US 2007/0197066 A1
(43) Pub. Date: Aug. 23, 2007

(54) ASSISTIVE MANUAL IMPLEMENT

(76) Inventor: LIsa M. L. Chang, Honolulu, HI (US)

Correspondence Address: KIRTON AND MCCONKIE, 60 EAST SOUTH TEMPLE,, SUITE 1800, SALT LAKE CITY, UT, 84111, US

(21) Appl. No.: 11/677,138

(22) Filed: Feb. 21, 2007

Related U.S. Application Data
(60) Provisional application No. 60/776,086, filed on Feb. 23, 2006.

(51) Int. Cl. H01R 13/44

(52) U.S. Cl. 439/136

(57) ABSTRACT

A manual implement that facilitates a person's ability to perform and participate in everyday life activities and may include a first arm and a second arm pivotally connected to the first arm. The first arm may be biased away from the second arm. The first arm may also include a longitudinal axis, a finger guide, and a plurality of connection locations with the finger guide selectively connected to the first arm at one of the connection locations and selectively disposed at an angle to the axis. The second arm may include a thumb guide and a longitudinal axis so that the thumb guide may be selectively disposed at an angle to the axis of the second arm. The manual implement may also include a weight attached proximate the connection between the first arm and the second arm.

### CROSS-REFERENCE TO RELATED APPLICATION

This application claims the benefit of U.S. Provisional Application No. 60/776,086, filed Feb. 23, 2006.

### BACKGROUND OF THE INVENTION

This invention relates generally to assistive manual implements or utensils for use primarily by persons who have difficulty using ordinary implements in the conduct of their everyday life activities. For example, persons may have difficulty eating, performing personal care and grooming, writing, engaging in hobbies or craftwork, etc. because of physical limitations and challenges in using traditional manual utensils, tools, and implements.

Maintaining a person's independent life skills is important for physical and psychological well-being. Remaining independent and self-reliant in performing ordinary life skills promotes a person's health, self-esteem, feeling of self-worth, and optimism. This independence and self-reliance capability is one of the deciding factors for maintaining a healthy, optimistic view on life; loss of this capability often contributes to the development of debilitating depression. This can be especially true where a person has lost the ability to feed and care for oneself with the ordinary manual utensils and implements currently available.

A person's difficulty in holding, gripping, and using ordinary implements may develop with age, or be caused by physical injuries or infirmities, reliance on prosthetics, learning disabilities, or the loss of mental capacity. For example, a person may be mentally or otherwise learning disabled and may have great difficulty using ordinary manual implements. A person may develop arthritis, such as rheumatoid or osteoarthritis, that may reduce hand strength and movement, or result in deformation of the hands, such as ulnar drift. A person may develop blindness, Parkinson's disease, or other neurologic or neuromuscular degenerative conditions that may make the use of ordinary manual utensils and implements difficult or impossible.

Maintaining a person's independent life skills for as long as possible is important and desirable due to financial considerations. The costs to provide care and assistance to persons who have difficulty using ordinary manual utensils just to feed themselves continue to escalate. A caregiver may be required to help feed persons unable to use conventional implements. The caregiver may be a family member, an independent contractor, or a health care facility employee; in any case, an enormous amount of time, energy, and financial resources are consumed in order to meet this basic need. It would be an improvement in the art to provide assistive manual implements which enable persons to feed themselves and perform common personal care and grooming without the need for caregivers to do so.

This challenge is growing rapidly due to the significant worldwide aging population increase, particularly of persons over the age of 65. It is estimated that 15% of the United States' elderly population will have serious illnesses or be otherwise be disabled to the point that they must be cared for by family members or institutions. Accordingly, the need exists for assistive manual implements to promote the independent life skills of people of all ages and ability who may have difficulty holding, gripping, or using ordinary utensils and implements.

### BRIEF SUMMARY OF THE INVENTION

The apparatus of the present invention has been developed in response to the present state of the art, and in particular, in response to the problems and needs in the art that have not been fully solved by currently available assistive manual implements. Thus, the present invention provides an assistive manual implement which facilitates a person's ability to perform and participate in everyday life activities. The invention is ergonomically designed to provide an adjustable, multi-use manual implement that enhances ambidexterity, especially for persons with physical limitations and challenges in using traditional manual utensils, tools, and implements.

The manual implement includes a first arm pivotally connected to a second arm. In some configurations of the manual implement the first and second arms may be brought together to grip food and other objects permitting the user to maintain a relatively independent life style.

The connection between the first arm and the second arm may be a hinged pivot. Alternatively, the first arm may be integrally formed with the second arm as a unitary body so that the connection is compliant material extending between the first arm and the second arm.

The connection may also include a biasing mechanism that biases the first arm away from the second arm. More specifically, the biasing mechanism may be a spring or the elastic deformation of the integrally formed connection. Of course, the biasing mechanism may also bias the first arm toward the second arm.

The first arm includes a longitudinal axis and a finger guide. The finger guide may be connected to the first arm so that it may be selectively disposable at an angle to the axis. To provide a connection between the finger guide and the first arm that permits the finger guide to be selectively disposable at an angle to the axis, the finger guide may be pivotally coupled to the first arm by a rivet or a pin.

In some configurations, the finger guide may be selectively disposed at a limited number of angles to the first arm ranging from about 0 degrees to about 180 degrees. In other configurations, the finger guide may be disposed at a limited number of angles to the first arm ranging from about 85 degrees to about 135 degrees.

A frictional member may be disposed between the finger guide and the first arm to resist movement between the first arm and the finger guide. The frictional material may be an elastomeric material, such as rubber or neoprene. Alternatively, the frictional material may be a surface finish on the first arm and the finger guide.

Alternatively, the connection between the first arm and the finger guide may include a plurality of radial grooves disposed about the pivotal connection between the finger guide and the first arm. In this configuration, the finger guide includes a ridge that engages one of the plurality of grooves to selectively dispose and retain the finger guide at an angle to the longitudinal axis of the first arm. The finger guide may be biased against the first arm by a spring in order to retain the ridge within the groove, which resists movement of the finger guide relative to the first arm.

Where the finger guide may only be disposed at a limited number of angles, radial grooves are only provided at those limited angles. By limiting the number of angles, rotation between the finger guide and first arm may be further controlled.

The first arm may also include a plurality of connection locations, wherein the finger guide may be selectively connected to the first arm at one of the connection locations.

The second arm may include a thumb guide and a longitudinal axis. Similarly to the finger guide, the thumb guide may be selectively disposable at an angle to the axis of the second arm and may be disposable at a plurality of connection locations in order to better fit the hand of a user.

The finger guide and the thumb guide may be made of metal or plastic. In some configurations, the finger guide and the thumb guide may have a metal core covered with an elastomeric material, such as rubber, polyurethane, and other elastomeric materials known in the art.

The manual implement may include one or more weights attached proximate the connection between the first arm and the second arm. The weights may help steady a user's hand and improve the user's control and use of the manual implement.

At the distal ends of the first and second arms, which are opposite the connection between the first arm and the second arm, a variety of tools may be attached. In some configurations, the distal ends of the first and second arms may each be shaped as a spoon.

In other configurations, the first and second arms may each comprise an attachment mechanism configured to removably attach tools to each respective arm. The tools may include eating utensils such as forks, spoons, knives, chopsticks, tongs; writing instruments, such as pencils, pens, and styli; personal care and grooming implements such as toothbrushes, combs, brushes, and tweezers; tools and hobby implements such as pliers, scissors, knives, screwdrivers, knitting needles, paint brushes, spatulas, and other implements known in the art. The invention may also include a gripping device configured to hold an ordinary utensil.

In yet further embodiments, the implement will only have a first arm and will lack a second arm or a hinge. Rather, in this embodiment, the implement will include a thumb grip that is positioned on the bottom side of the first arm which may be gripped by the user's thumb. The thumb grip provides a convenient and efficient surface that may be gripped by the user's thumb.

The implement allows persons of all ages, young and old alike, who have hand ailments or other anatomical or physiological problems to feed themselves or perform other tasks with dignity, self-respect, poise, and pride gained through renewed independence and self-reliance, regardless of skill level.

These and other features and advantages of the present invention will become more fully apparent from the following description and appended claims, or may be learned by the practice of the invention as set forth hereinafter.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a perspective view of a manual implement according to the invention;

FIG. 2A is a cross sectional view along lines 2A-2A of the connection between the first arm and the finger guide of the manual implement of FIG. 1;

FIG. 2B is a side elevation view of an alternative connection between the first arm and the finger guide of the manual implement of FIG. 1;

FIG. 3 is a top view of the grooves of the positioning member;

FIG. 4 is a top view of a first arm and a finger guide of a manual implement;

FIG. 4A is a side elevation view of the connection between the first arm and the finger guide of FIG. 4;

FIG. 5 is a perspective view of another configuration of a manual implement;

FIG. 6 is a cross sectional view along line 6-6 of the manual implement of FIG. 5;

FIG. 7 is a cross sectional view along line 7-7 of the manual implement of FIG. 5;

FIGS. 8A-8D are perspective views illustrating some tools that may be removably attached to the manual implement of FIG. 5;

FIG. 9 is a perspective view of a gripping device configured to hold an ordinary utensil that may be removably attached to the manual implement of FIG. 5; and

FIG. 10 is a perspective view of a further configuration of a manual implement that is similar to the embodiment of FIG. 5.

### DETAILED DESCRIPTION OF THE INVENTION

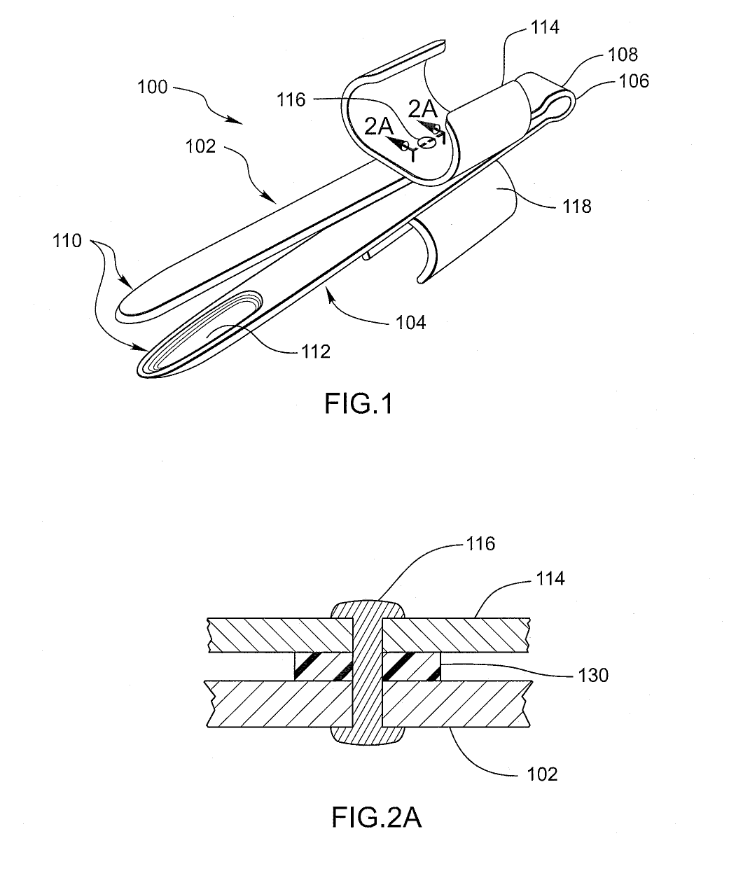

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the manual implement of the present invention, as represented in FIGS. 1 through 9, is not intended to limit the scope of the invention, as claimed, but is merely representative of presently preferred embodiments of the invention.

As shown in FIG. 1, a perspective view illustrates a manual implement 100 having a first arm 102 pivotally connected and integrally formed with a second arm 104. The connection 106 between the first arm 102 and the second arm 104 is compliant and acts to permit the first arm 102 to be pivoted toward and away from the second arm 104. The connection 106 also acts as a biasing mechanism 108 to bias the first arm 102 toward or away from the second arm 104 when the first arm 102 is moved from the neutral position, as shown.

Opposite the connection 106 are the distal ends 110 of the first and second arms 102, 104. The distal ends 110 may each include a tool 112 resembling a spoon. The tools 112 may be used by a user to grasp and hold food, liquids, and objects.

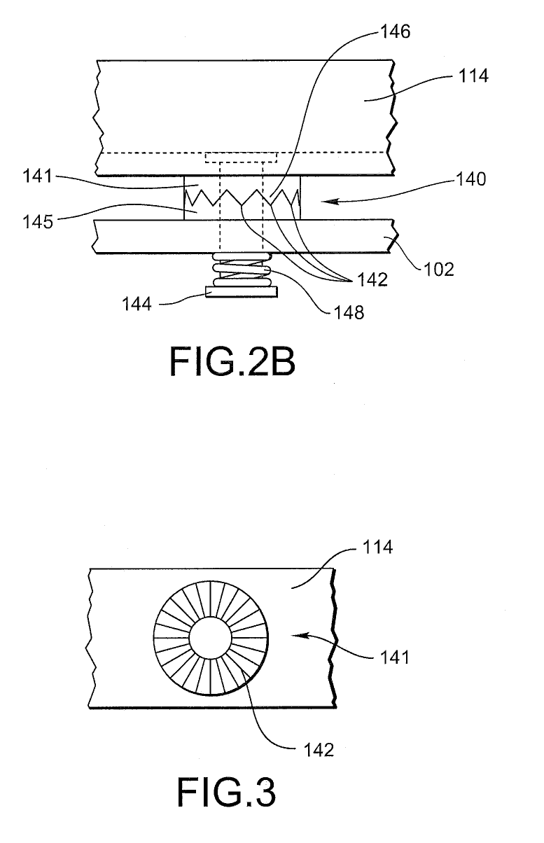

Additionally, the first arm 102 may be pivotally connected to a finger guide 114 by a pin 116. Similarly, a thumb guide 118 may be pivotally connected to the second arm 104 by a pin (not shown). The pin 116 may be a rivet, screw, bolt, or other mechanical fastener known in the art. More specifically and as shown in FIG. 2A, a cross sectional view along lines 2-2 of FIG. 1 illustrates the pin 116 connecting the first arm 102 with the finger guide 114.

As shown in FIG. 2A, a frictional member 130 may be disposed between the finger guide 114 and the first arm 102 to resist movement between the first arm 102 and the finger guide 114. The frictional material 130 may be an elastomeric material, such as rubber or neoprene. When assembled, the pin 116 may compress the frictional material 130 between the finger guide 114 and the first arm 102. The compression of the frictional member 130 provides a frictional force between the finger guide 114 and the first arm 102 that must be overcome in order to pivot the finger guide 114 relative to the first arm 102.

Additionally, the frictional member 130 may deform to provide temporary movement between finger guide 114 and the first arm 102. This temporary movement provides a more comfortable guide during use as the finger guide 114 conforms to the position and motion of the user's hand while grasping the manual implement 100.

Referring to FIG. 2B, a side elevation view illustrates an alternative pivotal connection 140 between the first arm 102 and the finger guide 114 of the manual implement 100. As shown, the first arm 102 may include positioning member 141 having a plurality of radial grooves 142 disposed about a pin 144. The pin 144 pivotally connects and extends between the first arm 102 and the finger guide 114. The finger guide 114 may include a reciprocal positioning member 145 having a ridge 146 that engages one of the plurality of grooves 142. A spring 148 biases the ridge 146 and the groove 142 into engagement and helps to resist movement of the finger guide 114 relative to the first arm 102.

When a change is desired in the position of the finger guide 114 relative to the first arm 102, the ridge 146 of the finger guide 114 may be moved out of engagement with the grooves 142 of the first arm 102 to compress the spring 148 and the finger guide 114 positioned relative to the first arm 102.

FIG. 3 further illustrates a configuration of the positioning member 141. As shown, the positioning member 141 may include grooves 142. It is intended that grooves 142 of the positioning member 141 engage corresponding ridges 146 of the reciprocal positioning member 145. It will be appreciated that when a positioning member 131 is mated with a reciprocal positioning member 145, such as illustrated in FIG. 2B, the grooves 142 and ridges 146 surround the pivotal connection 140. The grooves 142 and ridges 146 provide multiple points of contact and a secure connection between the first arm 102 and the finger guide 114.

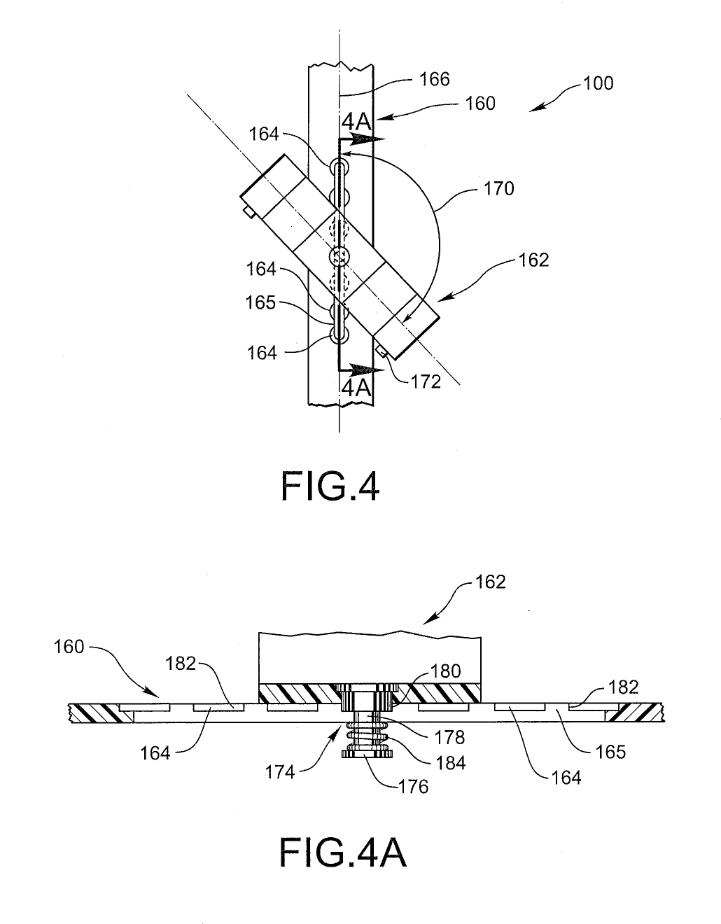

FIG. 4 is a top view of an alternative first arm 160 and finger guide 162 of the manual implement 100. As shown, the first arm 160 includes a plurality of connection points 164 and connecting slot 165 extending between them. The plurality of connection points 164 and the connecting slot 165 permit the finger guide 162 to be selectively positioned and pivotally connected to any one of the plurality of connection points 164 permitting the manual implement 100 to be fitted to the user for increased comfort.

Additionally, the first arm 160 may include a longitudinal axis 166. The finger guide 162 may be disposed at an angle 170 to the longitudinal axis 166 of the first arm 160 ranging from about 0 degrees to about 180 degrees. Alternatively, the finger guide 162 may be disposed at an angle 170 to the first 160 arm ranging from about 85 degrees to about 135 degrees.

The first arm 160 may also be limited in the range of angles 170 in which it may be disposed. To limit the range of angles 170 at which the finger guide 162 may be disposed relative to the first arm 160, the finger guide 162 may include limiting extensions 172 that prevent further rotation relative to the first arm 160 beyond the desired range of angles 170. The limiting extensions 172 extend downward to engage the first arm 160 at the maximum angles 170 of the desired range of angles 170.

Referring to FIG. 4A, a side elevation view illustrates the plurality of connection points 164 of the first arm 160 and the pivotal connection 174 of the finger guide 162 to one of the connection points 164. As shown, the finger guide 162 may be connected to the first arm 160 by a pin 176.

The pin 176 may include a narrow neck 178 that permits the pin 176 to slide in the connecting slot 165 between the connecting points 164. A wide shaft 180 of the pin 176 permits engagement and retention of the pin 176 in one of the connecting points 164 which has a similarly wide retention impression 182. The pin 176 may be retained in one of the connection points 164 by the spring 184.

To change the position of finger guide 162 relative to the first arm 160, the finger guide is raised to disengage the wide shaft 180 from the retention impression 182 and to compress the spring 184. The pin 176 is slide along the connecting slot 165 to the desired connecting point 164 where the wide shaft 180 is permitted to engage the retention impression 182 of the desired connecting point 164.

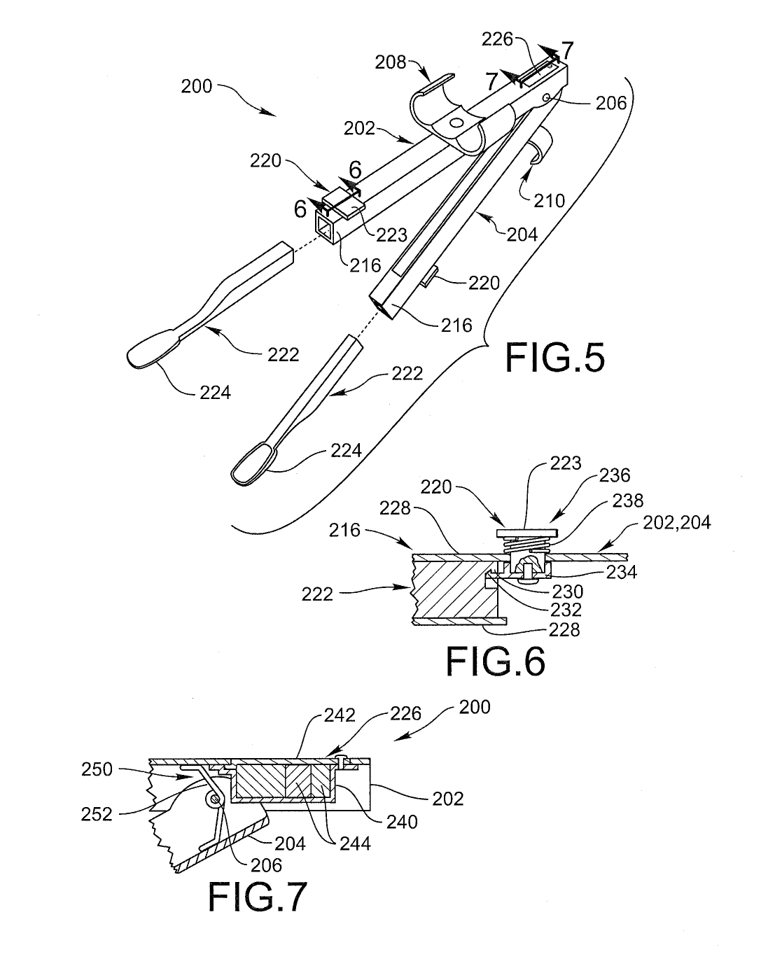

Referring to FIG. 5, a perspective view illustrates another configuration of the manual implement 200. As shown, the manual implement 200 may include a first arm 202 pivotally connected to a second arm 204 by a hinge 206. A finger guide 208 may be connected to the first arm 202 and a thumb guide 210 may be connected to the second arm 204.

The finger guide 208 and the thumb guide 210 may be covered by an elastomeric or plastic coating (not shown) for increased comfort. The finger guide 208 and the thumb guide 210 may also be ergonomically shaped to better conform to the shape of the fingers and thumb of a user's hand.

Opposite the hinge 206, at the distal ends 216 of the first arm 202 and the second arm 204, are attachment mechanisms 220 configured to removably attach one of the tools 222, which will be discussed below in relation to FIG. 6. The attachment mechanism 220 includes a control surface 223 that may be easily engaged by a user to actuate the attachment mechanism 220 to release an attached tool 222. As shown, the tool 222 may be a spoon 224.

Additionally, the manual implement 200 may include a weight coupling feature 226 that permits a weight (shown in FIG. 7) to be attached to the manual implement and disposed near the pivotal connection of the hinge 206. This positions the weight near the palm of a user's hand when the manual implement 200 is being used. Consequently, the weight may help steady the hands of user's afflicted by neurological damage.

FIG. 6 is a cross sectional view taken along line 6-6 of FIG. 5 which illustrates the attachment mechanism 220 of the manual implement 200. As shown, one of the tools 222 is connected to the attachment mechanism 220 and disposed within the distal end 216 of the one of the first or second arms 202, 204. The walls 228 of the first or second arms 202, 204 help to support and orient the tool 222.

The tool 222 includes an engagement feature 230 that may be brought into positive engagement with the retention feature 232 of the attachment mechanism 220.

The retention feature 232 is part of a cap 234 that is attached to button 236 opposite the control surface 223. The retention feature 232 may include an angled surface that permits a tool 222 to abut and slide over the retention feature 232 until retention feature 232 is brought into engagement with the engagement feature 230 of the tool 222. The button 236 may be biased by a spring 238 to maintain the retention feature 232 in engagement with the engagement feature 230. It will be appreciated that other releasable retention features, such as releasable snap-fit engagement mechanisms, may be used to secure the tool 222 to the first or second arms.

Referring to FIG. 7, a cross sectional view along line 7-7 of FIG. 5 illustrates the weight coupling feature 226 of the manual implement 200 being disposed near the hinge 206. The weight coupling feature 226 may include holder 240 and a lid 242 for concealing one or more weights 244 within the manual implement 200. The weights 244 may have different densities and sizes in order to better customize the manual implement to a user's needs.

Also shown, the manual implement 200 may include a biasing mechanism 250, such as a spring 252, for biasing the first arm 202 away from the second arm 204.

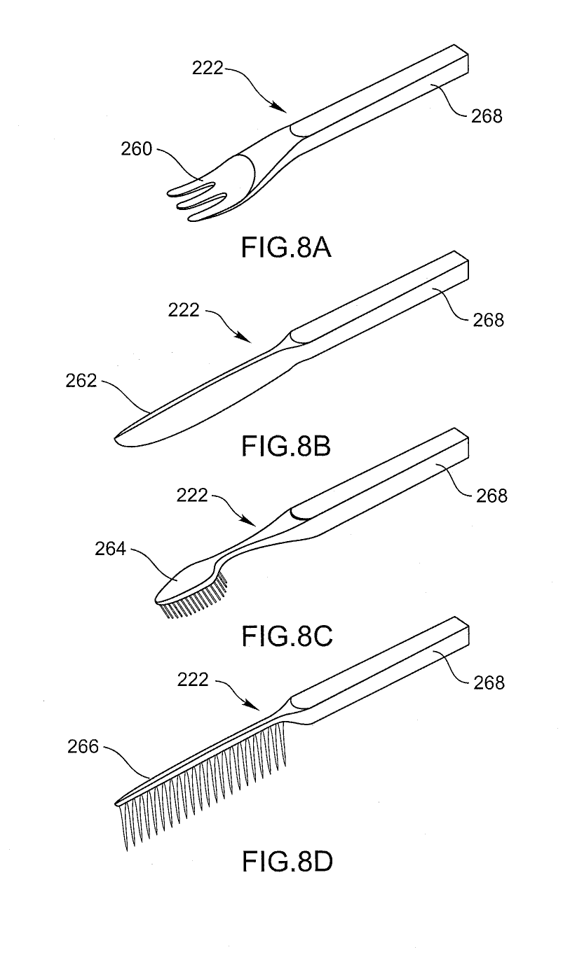

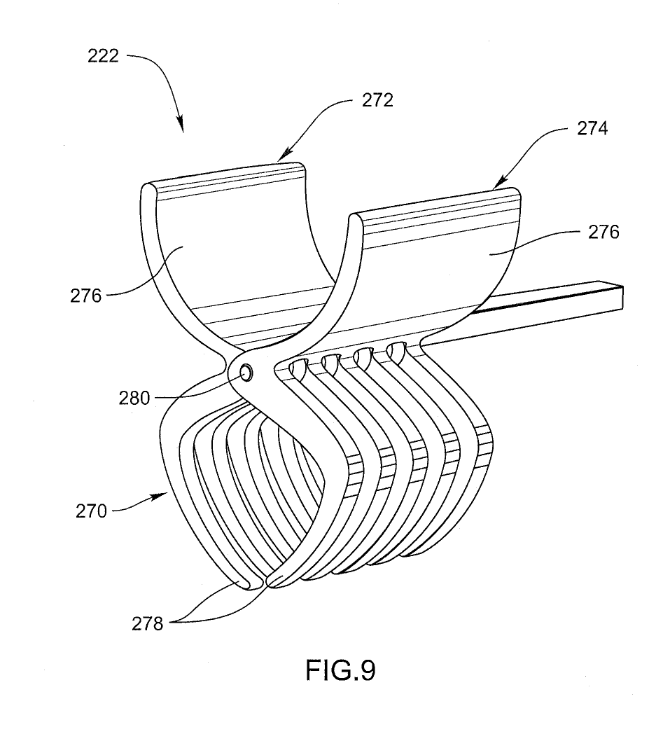

Referring to FIGS. 8A-8D, perspective views illustrating some possible tools 222 that may be removably attached to the manual implement 200 of FIG. 5. As shown, the tools 222 may include a fork 260, a knife 262, a tooth brush 264, and a comb 266. Each of the tools includes an attachment end 268 for coupling the tool 222 to the attachment mechanisms 220 of the manual implement 200 shown in FIG. 5. It will be appreciated that the invention may be used with a variety of other tools and implements not shown in FIGS. 8A-8D, including but not limited to eating utensils, writing instruments, personal care and grooming implements, tools and hobby implements, and other useful implements known in the art.

FIG. 9 illustrates another tool 222 that includes a gripping device 270 configured to hold ordinary utensils (not shown). The gripping device 270 includes a first lever arm 272 and a second lever arm 274 that each provides a large control surfaces 276 and gripping end 278.

A pivot 280 connects the first and the second lever arms 272, 274. The pivot 280 is disposed to provide a mechanical advantage when the control surfaces 276 are engaged to move the gripping ends of the first and the second lever arms 272, 274 away from each other. Consequently, the hand strength of a user required to operate the gripping device 270 is minimized. The gripping ends 278 may optionally be coated with a coating that enhances the gripping ability of the gripping device 270. Such coating may include an elastomeric or rubber-like coating. The coating may include a roughened surface to enhance frictional engagement between the gripping ends and the ordinary utensil.

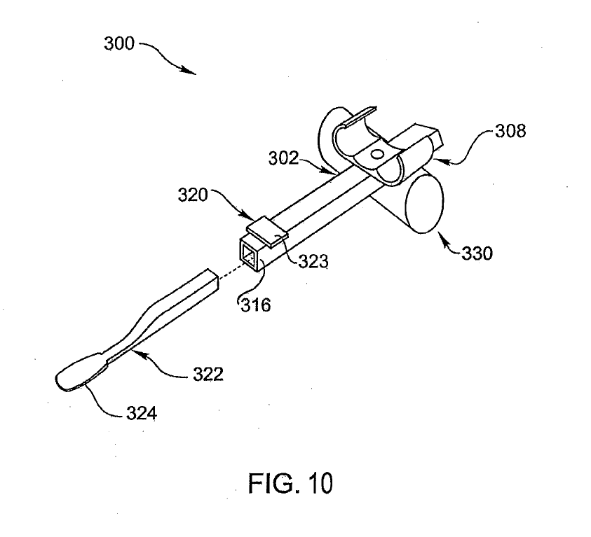

Referring to FIG. 10, a perspective view illustrates another configuration of the manual implement 300. The manual implement 300 is similar to the manual implement 200 that is described above in conjunction with FIGS. 5-9. Accordingly, much of the above-recited description of the features/characteristics of the manual implement 200 of FIG. 5 may likewise apply to the manual implement 300 of FIG. 10. However, for purposes of brevity, much of the above-recited description will not be repeated.

As shown, the manual implement 300 may include a first arm 302. However, unlike some of the previous embodiments, the manual implement 300 does not include a second arm, thumb guide, or a hinge. The manual implement 300 may also include a finger guide 308 that is connected to the first arm 302. The finger guide 308 may be covered by an elastomeric or plastic coating (not shown) for increased comfort. The finger guide 308 may also be ergonomically shaped to better conform to the shape of the fingers and thumb of a user's hand.

An attachment mechanism 320 may be positioned at the distal end 316 of the first arm 302. A variety of different attachment mechanisms 320 may also be used. The attachment mechanism 320 is configured to removably attach one or more of the tools 322 to the manual implement 300. As shown in FIG. 10, the tool 322 is a spoon 324. Of course, tools other than a spoon may also be used. For example, any of the devices shown in FIGS. 8A-8D may be used as the tool 322. Still further embodiments may be constructed in which the tool 322 comprises, for example, eating utensils, writing instruments, personal care and grooming implements, tools and hobby implements, and other useful implements known in the art. The manual implement 300 is particularly configured for use with single tools 322 instead of paired tools.

In the embodiment shown in FIG. 10, the attachment mechanism 320 includes a control surface 323 that may be easily engaged by a user to actuate the attachment mechanism 320 to release an attached tool 322. In other words, if the user actuates the control surface 323, the tool 322 will be released from the attachment mechanism 320.

As noted above, the manual implement 300 does not include the thumb guide found in the embodiment shown in FIG. 5. Rather, the manual implement 300 includes a thump grip 330 that is positioned on the bottom side of the first arm 302. As shown in FIG. 10, the thumb grip 330 is added to the first arm 302 such that it is positioned below the finger guide 308. The thumb grip 330 provides a surface to which the user's thumb may grip so that the user can manipulate the manual implement 300. The thumb grip 330 shown in FIG. 10 is in the form of a cylinder. It will be appreciated by persons having ordinary skill in the art that the thumb grip 330 may be configured in a variety of different shapes and sizes, including ergonomically designed shapes that provide a comfortable and efficient gripping surface. In some embodiments, the thumb grip 330 will be attached such that it may pivot separately from the first arm 302 and/or the finger guide 308. However, in other embodiments, the thumb grip 330 will not be able to pivot or move separately from the first arm 302/finger guide 308.

In conclusion, a manual implement has been provided that may be made by stamping, bending, and other machining processes known in the art. The manual implement includes arms which may be integrally formed together and be connected to selectively positionable finger and thumb guides which permit the manual implement to be specifically fitted to a user for maximum comfort and use. The thumb guides of the manual implement may be attached similarly to the finger guides discussed above.

Additionally, the manual implement may be operated by gross motor skills and does not require a user to use fine motor skills or to move individual fingers which may aggravate swollen or damaged joints in the hands. Instead, control over the arms of the manual implement are provided by flexing the larger muscles of the user's hands and arms, while avoiding the smaller muscles of the hands often required for the use of ordinary tools, utensils and implements.

The manual implement may also include weights which may be tailored to a user's specific needs and positioned near the palm of the user's hand. These weights may be helpful is steadying and minimizing the jerking associated with diseases of the nervous system, such as Parkinson's disease.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. A manual implement comprising:
a first arm comprising a longitudinal axis and a finger guide, wherein the finger guide is connected to the first arm and is selectively disposable at an angle to the axis; and
a second arm pivotally connected to the first arm.

2. The manual implement of claim 1, wherein the second arm comprises a thumb guide and a longitudinal axis, wherein the thumb guide is connected to the second arm and is selectively disposable at an angle to the axis of the second arm.

3. The manual implement of claim 1, wherein the first arm further comprises a frictional member disposed between the finger guide and the first arm, wherein the frictional member resists movement between the first arm and the finger guide.

4. The manual implement of claim 1, wherein the first arm further comprises a plurality of radial grooves disposed about the pivotal connection of the finger guide and the first arm, wherein the finger guide comprises a ridge that engages one of the plurality of grooves, wherein the grooves and the ridge cooperate to selectively dispose the finger guide at an angle to the longitudinal axis of the first arm and to resist movement of the finger guide relative to the first arm.

5. The manual implement of claim 4, wherein the finger guide is biased toward the first arm by a spring.

6. The manual implement of claim 1, wherein the finger guide is disposed at an angle to the first arm ranging from about 0 degrees to about 180 degrees.

7. The manual implement of claim 1, wherein the finger guide is disposed at an angle to the first arm ranging from about 85 degrees to about 135 degrees.

8. The manual implement of claim 1, wherein the first arm comprises a plurality of connection locations, wherein the finger guide may be selectively connected to the first arm at one of the connection locations.

9. The manual implement of claim 1, further comprising an attachment mechanism configured to removably attach a tool to the first arm.

10. The manual implement of claim 9, wherein the tool comprises a gripping device configured to hold an ordinary utensil.

11. The manual implement of claim 1, further comprising a weight attached proximate the connection between the first arm and the second arm.

12. The manual implement of claim 1, wherein the finger guide comprises metal core covered with an elastomeric material.

13. The manual implement of claim 1, wherein the first arm further comprises a plurality of connection locations, wherein the finger guide is selectively connected to the first arm at one of the connection locations and wherein the second arm comprises a thumb guide and a longitudinal axis, wherein the thumb guide is connected to the second arm and is selectively disposable at an angle to the axis of the second arm.

14. The manual implement of claim 13, further comprising an attachment mechanism configured to removably attach a tool to the first arm.

15. The manual implement of claim 14, wherein the tool comprises a gripping device configured to hold an ordinary utensil.

16. The manual implement of claim 13, further comprising a weight attached proximate the connection between the first arm and the second arm.

17. A manual implement comprising:
a first arm comprising a longitudinal axis, a finger guide and a plurality of connection locations, wherein the finger guide is selectively connected to the first arm at one of the connection locations and is selectively disposable at an angle to the axis;
a second arm pivotally connected to the first arm, wherein the second arm comprises a thumb guide and a longitudinal axis, wherein the thumb guide is connected to the second arm and is selectively disposable at an angle to the axis of the second arm, wherein the first arm is biased away from the second arm; and
a weight attached proximate the connection between the first arm and the second arm.

18. A manual implement comprising:
a first arm comprising a longitudinal axis and a finger guide, wherein the finger guide is connected to the first arm and is selectively disposable at an angle to the axis;
an attachment mechanism configured to removably attach a tool to the first arm; and
a thumb grip attached to the first arm, wherein the thumb grip is located below the finger guide.

19. The manual implement of claim 18, wherein the thumb grip is selectively disposable at an angle to the axis of the first arm.
